(19) United States
(12) Patent Application Publication
(10) Pub. No.: US 2011/0119835 A1
(43) Pub. Date: May 26, 2011

(54) Multi-Function Bottle Opener

(76) Inventors: Mark R. Bates, Hillsboro, OR (US); Leisa Marie Bates, Hillsboro, OR (US)

(21) Appl. No.: 12/705,370

(22) Filed: Feb. 12, 2010

Related U.S. Application Data
(60) Provisional application No. 61/263,997, filed on Nov. 24, 2009.

(51) Int. Cl. B67B 7/44; B67B 7/04; B67B 7/18

(52) U.S. Cl. 7/155; 7/156; 53/492; 81/3.09

(57) ABSTRACT

A specialized bottle opener provides a cap opener for opening screw tops, and a corkscrew attached to the cap opener, for opening traditional wine bottles sealed with corks. A lever arm, common to both tools, extends radially outward to provide torque when using either the cap opener or the corkscrew. The cap opener comprises a customizable ring and a pedestal having an interior cavity. Disposed on the inner surface of the cavity is one or more gripping members, such as vertical ridges, which serve to grip the cap and retain it within the cavity after the cap is removed from the bottle. After pouring the wine, the waiter may release the cap by accessing it through openings in the pedestal. Regardless of how a wine bottle is sealed, the multi-function bottle opener serves to maintain the sophisticated wine-drinking experience that consumers have come to expect.

### RELATED APPLICATIONS

The present patent application claims benefit of a provisional patent application, 61/263,997 filed on Nov. 24, 2009.

### FIELD OF THE INVENTION

This invention relates to an apparatus and method for opening bottles, and more particularly, to a multi-function bottle opener for removing screw caps, corks, and other seals on wine bottles.

### BACKGROUND OF THE INVENTION

Despite centuries of use, corks have proven to be inferior to screw caps for the preservation and storage of wine. In addition, screw caps are less expensive, easier to manufacture, and more reliable than both natural and synthetic corks. For these reasons, wine makers world-wide are switching from using corks to using screw caps. However, the practice of using screw caps instead of traditional corks for sealing wine bottles has raised a marketing problem within the wine industry. The mystique and sophisticated image associated with fine wines is sustained by the look of a corked bottle, and by the ceremonial removal of the cork, which requires a special tool and a certain level of skill. Based on the number of different existing corkscrew designs, and the prestige and price commanded by such devices, it appears that, for many consumers of wine, a significant part of the wine-drinking experience is in the anticipation during the opening of the bottle, and the demonstration of skill and finesse on the part of the individual who removes the cork. Screw caps, on the other hand, require no special tool, and no special skill, which, for some consumers, takes the fun out of the wine-drinking experience. Most importantly, consumers have grown to expect fine, expensive wines to be corked and therefore some consumers have come to believe that a screw cap bottle indicates a cheap, inferior wine. If a waiter in an upscale restaurant or a winery presents a bottle of expensive wine and simply unscrews the cap and starts pouring, the customer may feel let down, embarrassed, or even cheated.

### BRIEF SUMMARY OF THE INVENTION

The present disclosure describes a multi-function bottle opener that solves the screw cap bottle dilemma for restaurateurs, tasting rooms at wineries, hoteliers, and hosts entertaining their friends and business associates. A preferred embodiment of the invention provides a cap opener for opening screw tops, as well as a standard waiter's corkscrew attached to the cap opener, for opening traditional wine bottles sealed with corks. The cap opener comprises a cap-engaging member having a gripping member adapted to engage and rotate a bottle cap disposed on a bottle, in response to a torque applied thereto. The corkscrew comprises a cork-engaging member for engaging a cork disposed in a bottle in response to a torque applied thereto. A lever arm, connected to both tools, extends radially outward from the cap-engaging member and the cork-engaging member to produce torque along a rotational axis passing through an opening of the bottle, when using either the cap opener or the corkscrew.

When using the corkscrew, the waiter inverts the device and twists the lever arm clockwise about a rotational axis; when using the cap opener, the waiter covers the cap and twists the lever arm counter-clockwise about the same rotational axis. Thus, both corked bottles and screw top bottles may be opened using a common tool, and the motions used to open them are not noticeably different. Furthermore, the cap opener comprises a pedestal having an interior cavity and a plurality of ridges which serve to grip the cap and retain it within the cavity after it is removed from the bottle. After pouring the wine, the waiter may then release the cap by accessing it through openings in the pedestal. Regardless of how a wine bottle is sealed, the multi-function bottle opener serves to maintain the feel of the wine-drinking experience that some consumers have come to expect.

The cap opener aspect of the present device alone, when the corkscrew tool is not installed, may be adapted for use in opening containers of various types and sizes having threaded caps, in addition to wine and beverage bottles. The lever arm is capable of applying extra torque to caps that are tightly sealed, or for aiding people with arthritis or other disabilities, for whom removing tight caps is particularly difficult. The cavity for retaining the cap and the openings for releasing the cap are unique features that distinguish the multi-function bottle opener according to the present invention from existing devices for removing threaded caps.

It is to be understood that this summary is provided as a means for generally determining what follows in the drawings and detailed description, and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is an exploded view of the main components in a preferred embodiment of a multi-function bottle opener.

FIG. 2 is a side elevation view of the multi-function bottle opener of FIG. 1 showing, in phantom, a helical cork-engaging member, a bottle opener, and a foil cutter, deployed in their fully extended positions.

FIG. 3 is a perspective side view of the multi-function bottle opener of FIG. 1 showing a screw cap retained in the interior cavity following removal from a bottle.

FIG. 4 is a top plan view showing both cap release notches in the multi-function bottle opener of FIG. 1.

FIG. 5 is a bottom plan view of the multi-function bottle opener of FIG. 1 showing a preferred embodiment of a gripping member in the form of vertical ridges along the inner surface of the interior cavity.

### DETAILED DESCRIPTION OF ILLUSTRATIVE EMBODIMENTS

In the following description many details are set forth to provide an understanding of the disclosed embodiments of the invention. However, upon reviewing this disclosure, it will become apparent to one skilled in the art that not all of the disclosed details may be required to practice the claimed invention and that alternative embodiments might be constructed without departing from the principles of the invention.

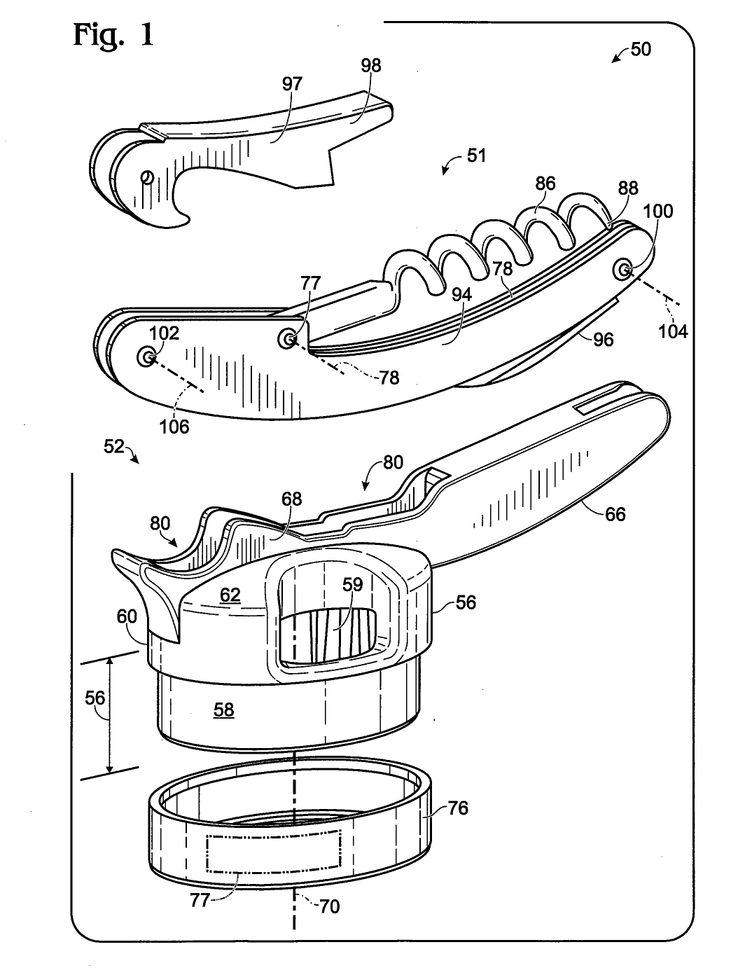

With reference to FIG. 1, an exploded view shows four main components of a multi-function bottle opener 50, and parts associated thereafter. According to a preferred embodiment, multi-function bottle opener 50 comprises a corkscrew 51, preferably made of stainless steel, removably attached to, or permanently mounted onto, a specialized cap opener 52, preferably made of an injection-molded plastic such as Polylac PA-747 Natural ABS, that is paintable or otherwise manufacturable in different colors and finishes. Cap opener 52 comprises a cap-engaging member 54 of a generally oval shape, that includes a pedestal 56, a ring 58, and an inner surface 59 featuring one or more gripping members. Cap engaging member 54 need not be continuous, but generally comprises one or multiple discrete concave arcuate portions of sufficient extent such that the gripping members on inner surface 59 engage a side of a bottle cap. Pedestal 56 preferably has a straight vertical sidewall 60, a domed upper surface 62, and an interior cavity 64, for retaining the cap. Cap opener 52 further comprises a lever arm 66 having a base 68 that is attached or molded to upper surface 62 of pedestal 56. Lever arm 66 extends radially outward from cap-engaging member 54 to provide torque substantially perpendicular to a rotational axis 70 passing through an opening of the bottle when cap-engaging member 54 is positioned to engage a cap 72 disposed on the bottle, or when corkscrew 51 is positioned to engage a cork disposed in the bottle.

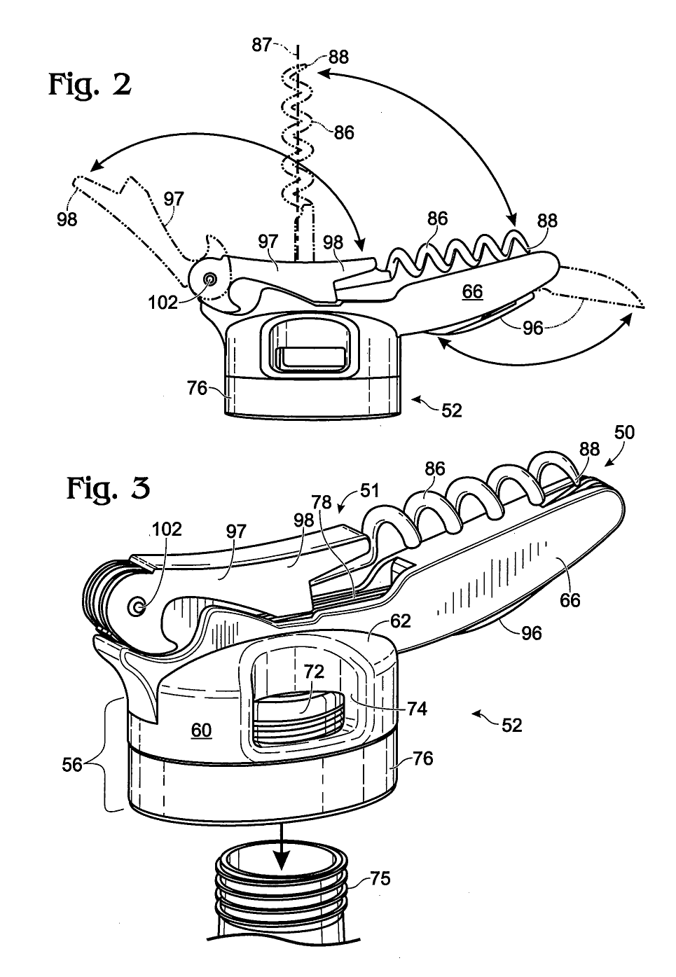

Pedestal 56 may include one or more openings in the form of a cap-release notch 74 to facilitate gripping the multi-function bottle opener 50, and to access interior cavity 64 for removing cap 72. For example, in FIG. 2, one of a pair of concave, arcuate cap release notches 74 is visible, notch 74 being of a shape and size so as to accommodate a fingertip for holding multi-function bottle opener 50, or for releasing a retained cap 72 by applying downward finger pressure to the top of cap 72. Ring 58 may include a removable sleeve 76, which may be made from one or more of many different material choices so as to contribute a customized finish to the appearance of multi-function bottle opener 50. Such materials may include, but are not limited to rubber (e.g., Pellethane 2103-70A Black), wood, decorative stone (e.g., marble, granite, and the like), and polished or anodized metals such as aluminum, pewter, silver, gold, and alloys thereof. Removable sleeve 76 may be embossed, engraved, inlaid, or otherwise decorated with a customized logo 77 such as the Torkscrew™ logo, or a logo representing, for example, a restaurant, hotel, or winery. Alternatively, removable sleeve 76 may be decorated with a monogram. If removable sleeve 76 is engraved, inlaid, or otherwise cut in forming logo 77, the sidewalls of the cuts are preferably angled along a radius to the center of the removable sleeve rather than the sidewalls being perpendicular to the surface of sleeve 76.

Corkscrew 51 preferably comprises a handle 78, to which one or more tools, including at least a cork-engaging member, may be pivotably attached. Corkscrew 51 may be an independent, “off-the-shelf” part, available from Rising Sun Industrial Co., Ltd. of Yangjiang, China, that may be inserted into and removed from lever arm 66 such that lever arm 66 surrounds a portion of handle 78 when corkscrew 51 is installed therein, as shown in the exploded view of the preferred embodiment of FIG. 1. Alternatively, handle 78 of corkscrew 51 may be permanently secured to lever arm 66, by an adhesive such as, for example, epoxy or glue; or handle 78 may simply comprise all or a portion of cap opener 52 itself. According to a preferred embodiment, base 68 of lever arm 66 that is molded to domed upper surface 62 includes a protective slot 80 into which corkscrew 51 may be inserted during manufacture of multi-function bottle opener 50.

With reference to the preferred embodiment of a multi-function bottle opener shown in FIGS. 1 and 2, tools pivotably attached to handle 78 include a cork-engaging member 86, having a central axis 87 and a pointed tip 88 for piercing the end of a cork stopper residing near the opening of a wine bottle. Cork-engaging member 86 is shown pivotably attached to handle 78 by a rivet 90 aligned along an axis 92 perpendicular to a surface plane 94 of handle 78. Additional tools such as, for example, a foil cutter 96 and a bottle cap remover 97 for removing a crimped bottle cap, as opposed to a threaded cap, are also shown pivotably attached to handle 78. Bottle cap remover 97 includes a notched end 98 for bracing corkscrew 51 against the rim of a bottle during use. These additional tools may be extended radially outward by pivoting around respective substantially parallel axes 100 and 102, along which rivets 104 and 106 are inserted into handle 78 for securing the tools. Axes 100 and 102 are each substantially parallel to axis 92. FIG. 2 shows each of these three exemplary tools in a partial or fully extended position in phantom dash-double-dotted lines, and in their folded positions in solid lines.

To remove a cork from a wine bottle using the multi-function bottle opener, foil cutter 96 is first rotated about axis 100 to its fully extended position aligned with handle 78. The tip of foil cutter 96 may then be used to cut and remove the end of the foil or lead seal covering the cork. Next, multi-function bottle opener 50 is inverted and cork-engaging member 86 is rotated around axis 92, until cork-engaging member 86 locks into place at its fully extended position such that central axis 87 aligns with rotational axis 70, as shown in phantom in FIG. 2. Cork-engaging member 86 may then be fully inserted into the cork stopper by twisting handle 78 that resides within slot 80 of lever arm 66. After cork-engaging member 86 is securely inserted into the cork, bottle cap remover 97 may be used as a brace. When bottle cap remover 97 is rotated about axis 102 to its full outward extension, notched end 98 may be braced against the rim of a bottle to provide a fulcrum about which multi-function bottle opener 50 may be rotated. In response to an upward force applied to lever arm 66, torque supplied by lever arm 66 lifts the cork out of the bottle.

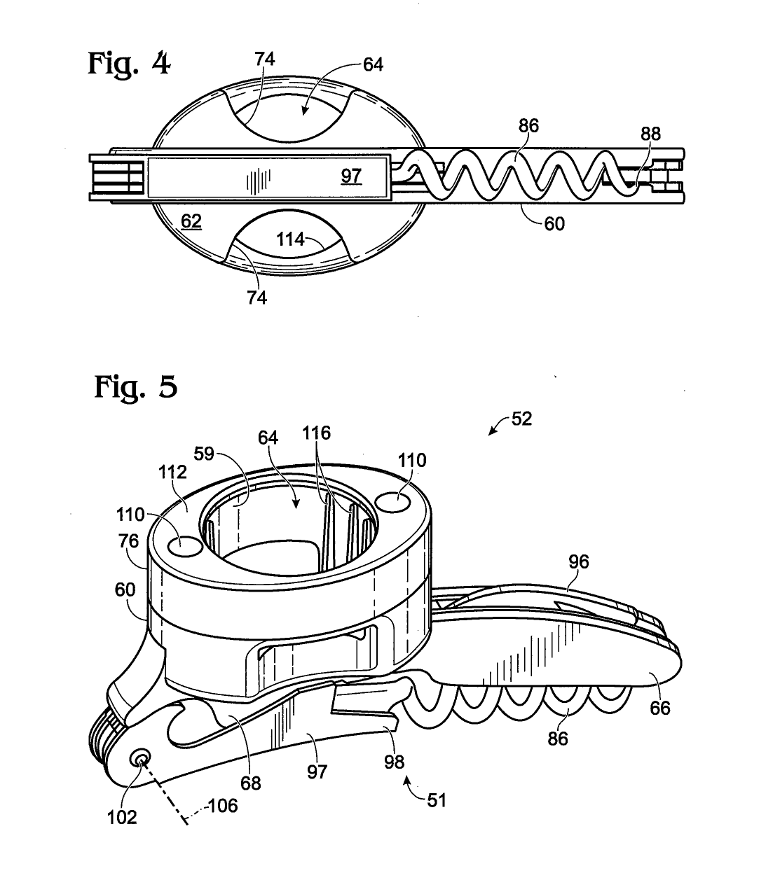

FIG. 3 shows a perspective view of a side elevation of multi-function bottle opener 50, fully assembled, in which screw cap 72, retained in interior cavity 64, is visible through a cap-release notch 74 after cap 72 has been removed from a wine bottle 75. FIG. 4 shows a top view of multi-function bottle opener 50, in which two concave arcuate cap release notches 74 are cut into opposite sides of pedestal 56, and corkscrew 51 is mounted between the two cap release notches 74.

FIG. 5 shows a perspective view of the underside of multi-function bottle opener 50, revealing details of cap-engaging member 54 not visible in FIGS. 1-4. For example, magnets 110 may be flush-mounted to a lower surface 112 of cap-engaging member 54 for securing multi-function bottle opener 50 to a metal surface, such as, for example, a cabinet, a refrigerator, or other appliance. Magnets 110 preferably have a strong magnetic field matched to, and sufficient to support, the weight of the multi-function bottle opener 50. According to a preferred embodiment, interior cavity 64 is generally round, having an inner surface 114. FIG. 4 shows inwardly-directed gripping members in the form of a plurality of vertical ridges 116 disposed on inner surface 114. Vertical ridges 116 serve to engage a bottle cap when cap opener 52 is placed over cap 72 and rotated counter-clockwise by applying a motive force to lever arm 66. An alternative embodiment may employ a gripping member in the form of a sticky or high-friction material lining the inner surface 114.

The terms and expressions that have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims which follow.

1. A bottle opener, comprising:
a cap-engaging member having a gripping member adapted to engage and rotate a bottle cap disposed on a bottle in response to torque applied to the cap-engaging member;
a corkscrew attached to the cap-engaging member for engaging a cork disposed in a bottle in response to torque applied to the corkscrew; and
a lever arm connected to the cap-engaging member and the corkscrew to provide torque substantially along a rotational axis when either the cap-engaging member is positioned to engage a cap disposed on the bottle or the corkscrew is positioned to engage a cork disposed in the bottle.

2. The bottle opener of claim 1, wherein the gripping member comprises at least one concave arcuate portion for engaging a side of the bottle cap.

3. The bottle opener of claim 2, wherein the gripping member comprises a plurality of ridges disposed on the interior of the concave arcuate portion for engaging a bottle cap.

4. The bottle opener of claim 2, wherein the arcuate portion comprises a ring for placement over a bottle cap.

5. The bottle opener of claim 1, wherein the cap-engaging member comprises a ring for placement over a bottle cap and a pedestal attached to the ring, the pedestal having a cavity therein for receiving a bottle cap inserted through the ring.

6. The bottle opener of claim 5, wherein the gripping member comprises a plurality of ridges disposed on the interior of the ring for engaging a bottle cap.

7. The bottle opener of claim 5, wherein the pedestal includes at least one opening in the side thereof adapted to expose portions of a bottle cap retained within the cavity.

8. The bottle opener of claim 6, wherein the opening comprises a cap release notch having a concave arcuate shape.

9. The bottle opener of claim 1, wherein the corkscrew comprises a cork-engaging member pivotably connected to a handle, the cork-engaging member having a central axis that, when extended, substantially aligns with the rotational axis.

10. The bottle opener of claim 9, wherein the corkscrew further comprises one or more additional tools pivotably connected to the handle so as to be extended radially outward therefrom, or folded inwardly within a protective slot, the tools consisting of foil cutters, blades and bottle cap removers.

11. The bottle opener of claim 1, wherein the lever arm includes a base that is attached to the cap-engaging member and the lever arm extends radially away from the rotational axis.

12. A cap opener, comprising:
a cap-engaging member having a gripping member adapted to engage and rotate a cap disposed on a container in response to torque applied to the cap-engaging member;
a cavity within the cap-engaging member, in which a cap may be received and retained; and
at least one opening formed in the cap-engaging member adapted to expose portions of the cap retained within the cavity.

13. The cap opener of claim 12, further comprising a lever arm connected to the cap-engaging member to provide torque substantially perpendicular to a rotational axis of the container when the cap-engaging member is positioned to engage a cap disposed on the container.

14. The cap opener of claim 12, wherein the gripping member comprises a plurality of ridges disposed on an inner surface of the cavity for engaging a cap.

15. The cap opener of claim 12, wherein the opening comprises a cap release notch having a concave arcuate shape.

16. A method of removing a cap from a container, comprising:
placing a cap-engaging member having a cavity, a cap release notch, and a lever arm, over the cap so as to engage the cap within the cavity;
applying force to the lever arm so as to rotate the cap and the cap-engaging member together, about a rotational axis of the container, until the cap is removed from the container;
retaining the cap within the cavity; and
releasing the cap from the cavity by accessing the cap through a cap release notch, and applying force to separate the cap from the cap-engaging member.
